(19) United States
(12) Patent Application Publication
(10) Pub. No.: US 2022/0391761 A1
(43) Pub. Date: Dec. 8, 2022

(54) MACHINE LEARNING DEVICE, INFORMATION PROCESSING METHOD, AND RECORDING MEDIUM

(71) Applicants: NEC CORPORATION, Tokyo (JP); THE UNIVERSITY OF TOKYO, Tokyo (JP)

(72) Inventors: Yusuke SAKEMI, Tokyo (JP); Kai MORINO, Tokyo (JP); Kazuyuki AIHARA, Tokyo (JP)

(73) Assignees: NEC CORPORATION, Tokyo (JP); THE UNIVERSITY OF TOKYO, Tokyo (JP)

(21) Appl. No.: 17/775,357

(22) PCT Filed: Oct. 27, 2020
(86) PCT No.: PCT/JP2020/040247

§ 371 Date: May 9, 2022

(30) Foreign Application Priority Data
Nov. 14, 2019 (JP) 2019-206438

(51) Int. Cl. G06N 20/00

(52) U.S. Cl. CPC G06N 20/00

(57) ABSTRACT

A machine learning device includes: an input unit that acquires input data; an intermediate calculation unit that performs calculation on the input data a plurality of times; a weighting unit that performs weighting on an output of the intermediate calculation means for each of the plurality of times; an output unit that outputs output data based on a result of the weighting by the weighting means; and a learning unit that performs learning of a weight obtained by the weighting by the weighting means.

### TECHNICAL FIELD

The present invention relates to a machine learning device, an information processing method, and a recording medium.

### BACKGROUND ART

Reservoir computing (RC) is a type of machine learning (see Non-Patent Document 1). Reservoir computing is capable of performing learning and processing of time series data in particular. Time series data are data representing a certain amount of temporal change, and examples thereof include voice data and climate change data.

Reservoir computing is typically configured with a neural network and includes an input layer, a reservoir layer, and an output layer. In reservoir computing, the weight of the connection from an input layer to a reservoir layer and the weight of the connection in the reservoir layer are not learned, and only the weight of the connection from the reservoir layer to an output layer (also referred to as weight of output layer) is learned, whereby high-speed learning is realized.

Reservoir computing is typically configured as a type of neural network, however, it is not limited thereto. For example, a one-dimensional delayed feedback dynamical system may be used to construct reservoir computing (see Non-Patent Document 2).

Moreover, the hardware implementation of reservoir computing is described in Non-Patent Document 3, for example.

### PRIOR ART DOCUMENTS

### Non-Patent Documents

Non-Patent Document 1: M. Lukosevicius and one other person, “Reservoir computing approaches to recurrent neural network training”, Computer Science Review 3, pp.127-149, 2009

Non-Patent Document 2: L. Appeltant and 8 others, “Information processing using a single dynamical node as complex system”, Nature Communications, 2:468, 2011

Non-Patent Document 3: G. Tanaka and 8 others, “Recent advances in physical reservoir computing: A review”, Neural Networks 115, pp.100-123, 2019

### SUMMARY OF THE INVENTION

### Problem to be Solved by the Invention

Since reservoir computing learns only the weight of an output layer, it requires a larger model size to achieve the same performance as compared to other models which learn that of layers other than an output layer.

When the model size is large, the calculation speed and power efficiency are low at the time of a prediction execution, and the circuit size becomes large when implementing hardware. Therefore, it is preferable that the model size can be made relatively small.

An example object of the present invention is to provide a machine learning device, an information processing method, and a recording medium capable of solving the problems mentioned above.

### Means for Solving the Problem

According to a first example aspect of the present invention, a machine learning device includes: input means that acquires input data; intermediate calculation means that performs calculation on the input data a plurality of times; weighting means that performs weighting on an output of the intermediate calculation means for each of the plurality of times; output means that outputs output data based on a result of the weighting by the weighting means; and learning means that performs learning of a weight obtained by the weighting by the weighting means.

According to a second example aspect of the present invention, an information processing method includes: acquiring input data; performing calculation on the input data a plurality of times; performing weighting on a calculation result at each time of the plurality of times; outputting output data based on a result of the weighting; and performing learning of a weight obtained by the weighting.

According to a third example aspect of the present invention, a recording medium stores a program causing a computer to execute: acquiring input data; performing calculation on the input data a plurality of times; performing weighting on a calculation result at each time of the plurality of times; outputting output data based on a result of the weighting; and performing learning of a weight obtained by the weighting.

### Effect of the Invention

According to example embodiments of the present invention, relatively high learning performance can be exhibited without the need for increasing the size of a model. Conversely, the size of a model can be reduced while maintaining the learning performance.

### BRIEF DESCRIPTION OF THE DRAWINGS

FIG. 1 is a diagram showing a schematic configuration of a reservoir computing system according to a first example embodiment.

FIG. 2 is a schematic block diagram showing an example of a functional configuration of a machine learning device according to the first example embodiment.

FIG. 3 is a diagram showing an example of data flow in a machine learning device according to a second example embodiment.

FIG. 4 is a diagram showing an example of state transition in an intermediate layer according to the second example embodiment.

FIG. 5 is a diagram showing an example of state transition in an intermediate layer according to a third example embodiment.

FIG. 6 is a diagram showing an example of data flow in a machine learning device according to a fourth example embodiment.

FIG. 7 is a diagram showing an example of state transition in an intermediate layer according to the fourth example embodiment.

FIG. 8 is a first diagram showing simulation results of a machine learning device according to an example embodiment.

FIG. 9 is a second diagram showing simulation results of a machine learning device according to an example embodiment.

FIG. 10 is a diagram showing an example of a functional configuration of a machine learning device according to a fifth example embodiment.

FIG. 11 is a diagram showing an example of data flow in the machine learning device according to the fifth example embodiment.

FIG. 12 is a diagram showing an example of calculation performed at respective times by a weighting unit according to the fifth example embodiment.

FIG. 13 is a diagram showing an example of a functional configuration of a machine learning device according to an example embodiment.

FIG. 14 is a diagram showing an example of a processing procedure in an information processing method according to an example embodiment.

FIG. 15 is a schematic block diagram showing a configuration of a computer according to at least one example embodiment.

### EXAMPLE EMBODIMENT

Hereinafter, example embodiments of the present invention are described, however, the present invention within the scope of the claims is not limited by the following example embodiments. Furthermore, all the connections of features described in the example embodiments may not be essential for the solving means of the invention.

### First Example Embodiment

(About Reservoir Computing)

Here is described reservoir computing, upon which example embodiments are based.

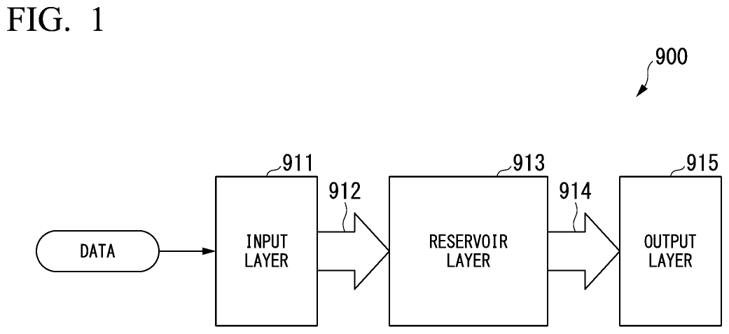

FIG. 1 is a diagram showing a schematic configuration of a reservoir computing system according to a first example embodiment. In the configuration shown in FIG. 1, a reservoir computing system 900 includes an input layer 911, a reservoir layer 913, an output layer 915, a connection 912 from the input layer 911 to the reservoir layer 913, and a connection 914 from the reservoir layer 913 to the output layer 915.

The input layer 911 and the output layer 915 are each configured by including one or more nodes. For example, if the reservoir computing system 900 is configured as a neural network, the nodes are configured as neurons.

The reservoir layer 913 is configured by including nodes and unidirectional edges that transmit data between the nodes of the reservoir layer 91 while multiplying the data by a weight coefficient.

In the reservoir computing system 900, data is input to the nodes of the input layer 911.

The connection 912 from the input layer 911 to the reservoir layer 913 is configured as a set of edges connecting the nodes of the input layer 911 and the nodes of the reservoir layer 913. The connection 912 transmits the value obtained by multiplying the value of a node of the input layer 911 by the weight coefficient, to a node of the reservoir layer 913.

The connection 914 from the reservoir layer 913 to the output layer 915 is configured as a set of edges connecting the nodes of the reservoir layer 913 and the nodes of the output layer. The connection 914 transmits the value obtained by multiplying the value of a node of the reservoir layer 913 by the weight coefficient, to a node of the output layer 915.

In FIG. 1, the connection 912 from the input layer 911 to the reservoir layer 913 and the connection 914 from the reservoir layer 913 to the output layer 915 are indicated by arrows.

The reservoir computing system 900 learns only the weight (value of the weight coefficient) of the connection 914 from the reservoir layer 913 to the output layer 915. On the other hand, the weight of the connection 912 from the input layer 911 to the reservoir layer 913 and the weight of the edges between the nodes of the reservoir layer are not subject to learning, and take a constant value.

The reservoir computing system 900 may be configured as a neural network, however, it is not limited thereto. For example, the reservoir computing system 900 may be configured as a model representing an arbitrary dynamical system expressed by Equation (1).

[Equation 1]

x(t)=f(x(t−Δt), u(t)),

y(t)=W^{out}x(t) (1)

Here, u(t)={u₁(t), u₂(t), . . . , u_{K}(t)} is an input vector constituting the input layer 911. K is a positive integer indicating the number of nodes in the input layer 911. That is to say, u(t) is a vector indicating input time series data to the reservoir computing system 900. Since the nodes of the input layer 911 take the value of the input data, u(t) is also a vector indicating the values of the nodes of the input layer 911.

x(t)={x₁(t), x₂(t), . . . ,x_{N}(t)} is a vector representation of the dynamical system constituting the reservoir layer 913. N is a positive integer indicating the number of nodes in the reservoir layer 913. That is to say, x(t) is a vector indicating the values of the nodes of the reservoir layer 913.

y(t)={y₁(t), y₂(t), . . . , y_{M}(t)} is an output vector. M is a positive integer indicating the number of nodes in the output layer 915. That is to say, y(t) is a vector indicating the values of the nodes of the output layer 915. Since the reservoir computing system 900 outputs the values of the nodes of the output layer 915, y(t) is also a vector indicating the output data of the reservoir computing system 900.

f(·) is a function representing the time evolution of the state of the reservoir layer 913.

Δt is a prediction time step, and takes a sufficiently small value according to the speed of change in the state of a prediction and learning target. The reservoir computing system 900 accepts an input from the prediction and learning target at each prediction time step Δt.

W^{out} is a matrix indicating the strength of connection from the reservoir layer 913 to the output layer 915. The elements of W^{out} indicate the weight coefficient at individual edges that make up the connection 914. Where R^{M×N} is a set of real number matrices having M rows and N columns, W^{out} ∈ given. W^{out} is also referred to as an output connection matrix or an output matrix.

When a neural network is used as a dynamical system (echo state network), Equation (1) is expressed as Equation (2).

[Equation 2]

x(t)=tanh(W^{res}x(t−Δt)+Wⁱⁿu(t)),

y(t)=W^{out}x(t) (2)

tanh (·) indicates a hyperbolic tangent function.

W^{res} is a matrix indicating the strength of connection between the neurons in the reservoir layer 913. The elements of W^{res} indicate the weight coefficient at individual edges between the nodes in the reservoir layer 913. Where R^{N×N} is a set of real number matrices having N rows and N columns, W^{res} ∈ R^{N×N} given. W^{res} is also referred to as a reservoir connection matrix.

Wⁱⁿ is a matrix indicating the strength of connection from the input layer 911 to the reservoir layer 913. The elements of Wⁱⁿ indicate the weight coefficient at individual edges that make up the connection 912. Where R^{N×K} is a set of real number matrices having N rows and K columns, Wⁱⁿ ∈R^{N×K} is given.

### (About Learning Rules)

In the reservoir computing system 900, learning of the output matrix W^{out} is performed, using the teaching data {u^{Te}(t), y^{Te}(t)}, (t=0, Δt, 2Δt, . . . , TΔt) composed of a pair of the value of an input vector and the value of an output vector yielded therefor. The superscripted Te in u^{Te}(t) indicates that it is an input vector for learning. The Te in y^{Te}(t) indicates that it is an output vector for learning.

When the reservoir layer 913 is time-evolved by the input vector u^{Te}(t) of this teaching data, vectors x(0), x(Δt), x(2Δt), . . . , x(TΔt) indicating the internal state of the reservoir layer 913 are obtained.

Learning in the reservoir computing system 900 is performed by using the internal state of the reservoir layer 913 to reduce the difference between the output vector y(t) and the teaching data y^{Te}(t) of the output vector.

For example, ridge regression can be used as a method for reducing the difference between the output vector y(t) and the teaching data y^{Te}(t) of the output vector. In the case where ridge regression is used, learning of the output matrix W^{out} is performed by minimizing the quantity shown in Equation (3).

$$\begin{matrix}[ Equation 3 ] & \\ {\sum }_{t = 0}^{T} {‖ y ( t Δ t ) - {y}^{Te} ( t Δ t ) ‖}_{2}^{2} + β {‖ {W}^{out} ‖}_{2}^{2} & ( 3 )\end{matrix}$$

Here, β is a parameter of a regular real number constant called a regularization parameter.

The subscripted “2” in ∥·∥₂² indicates the L2 norm, and the superscripted “2” indicates the square.

### (Hardware Implementation of Reservoir Computing)

By implementing reservoir computing in hardware, it becomes possible to perform calculations at higher speed and lower power consumption compared to the case of software execution of reservoir computing using a CPU (Central Processing Unit). Therefore, when considering a real-world application, it is important to consider not only the algorithm of reservoir computing but also the hardware implementation of reservoir computing.

Examples of hardware implementations for reservoir computing include electronic circuit implementation using a field programmable gate array (FPGA), a graphical processing unit (GPU), or an application specific integrated circuit (ASIC). The reservoir computing system 900 may also be implemented by any of these.

Furthermore, as an implementation of reservoir computing by other than electronic circuits, there is a report of implementation by physical hardware called a physical reservoir. For example, implementation by means of spintronics and implementation by means of an optical system are known. The reservoir computing system 900 may also be implemented by any of these.

### (About Configuration of Machine Learning Device)

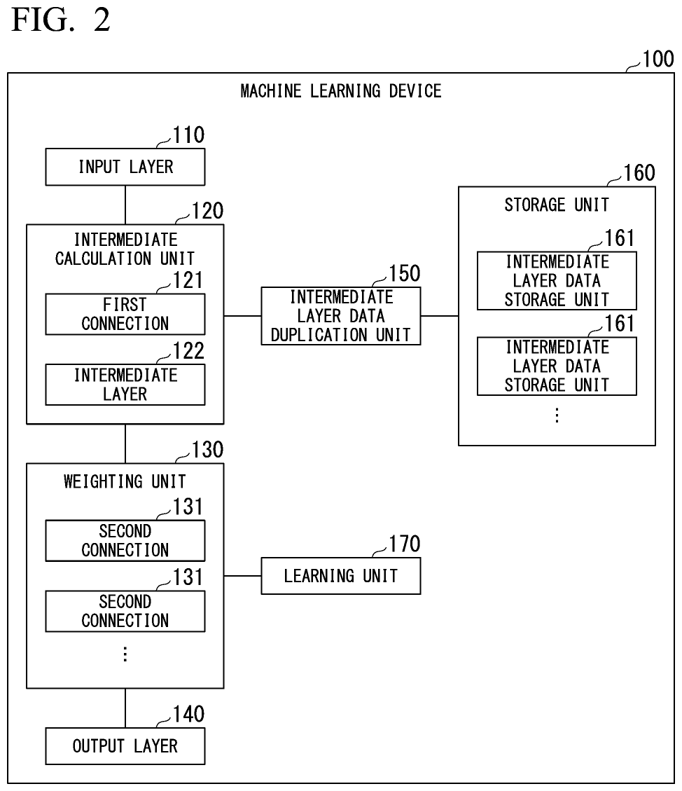

FIG. 2 is a schematic block diagram showing an example of a functional configuration of a machine learning device according to the first example embodiment. In the configuration shown in FIG. 2, a machine learning device 100 includes an input layer 110, an intermediate calculation unit 120, a weighting unit 130, an output layer 140, an intermediate layer data duplication unit 150, a storage unit 160, and a learning unit 170. The intermediate calculation unit 120 includes a first connection 121 and an intermediate layer 122. The weighting unit 130 includes second connections 131. The storage unit 160 includes intermediate layer data storage units 161.

As with the input layer 911 of the reservoir computing system 900 (FIG. 1), the input layer 110 includes one or more nodes and acquires input data to the machine learning device 100. The input layer 110 corresponds to an example of an input unit.

The intermediate calculation unit 120 performs calculation each time the input layer 110 acquires input data. In particular, the intermediate calculation unit 120 performs the same calculation once or a plurality of times each time the input layer 110 acquires input data. A calculation that serves as a unit of repetition performed by the intermediate calculation unit 120 is referred to as single calculation. When the intermediate calculation unit 120 repeats the same calculation, every single calculation yields a different result as either or both of the value of input data and the internal state of the intermediate calculation unit 120 (the internal state of the intermediate layer 122 in particular) differ.

The intermediate layer 122 is configured by including nodes and edges that transmit data between the nodes of the intermediate layer 122 while multiplying data by a weight coefficient.

The first connection 121 is configured as a set of edges connecting the nodes of the input layer 110 and the nodes of the intermediate layer 122. The first connection 121 transmits the value obtained by multiplying the value of a node of the input layer 110 by the weight coefficient, to a node of the intermediate layer 122.

The machine learning device 100 stores the state of the intermediate calculation unit 120 each time the intermediate calculation unit 120 performs calculation. In particular, the machine learning device 100 stores the values of the nodes of the intermediate layer 122 each time the intermediate calculation unit 120 performs calculation. Then, the machine learning device 100 transmits to the output layer 140 the value obtained by multiplying the output from the intermediate calculation unit 120 by the weight coefficient for each of the plurality of states including the stored states of the intermediate calculation unit 120. As a result, the machine learning device 100 can calculate the output of the machine learning device 100 (value of each node of the output layer 140), using the connection from the intermediate calculation unit 120 to the output layer 140 at a plurality of times. Therefore, the machine learning device 100 can calculate the output of the machine learning device 100 using a relatively large amount of data without having to increase the size of the intermediate calculation unit 120 (the number of dimensions of the intermediate layer 122 in particular), and in terms of this, highly accurate calculation of output is possible. The number of dimensions of a layer mentioned here refers to the number of nodes in that layer.

The storage unit 160 stores data. In particular, the storage unit 160 stores the state of the intermediate calculation unit 120 each time the intermediate calculation unit 120 performs a calculation.

The intermediate layer data storage unit 161 stores the state of the intermediate calculation unit 120 based on the result of a calculation at each time performed by the intermediate calculation unit 120 (the state of the intermediate calculation unit 120 when calculation at that time is completed). It should be noted that the time referred to here indicates the number of calculations, and does not necessarily indicate the actual (physical) time. The intermediate layer data storage unit 161 may store the value of each node of the intermediate layer 122 as the state of the intermediate calculation unit 120. Alternatively, in the case where only some of the nodes of the intermediate layer 122 are connected to the nodes of the output layer 140 by the edges, the intermediate layer data storage unit 161 may store the values of the nodes connected with the nodes of the output layer 140 by the edges, among the nodes of the intermediate layer 122.

The storage unit 160 can store the state of the intermediate calculation unit 161 for the number of the intermediate layer data storage units 161.

The intermediate layer data duplication unit 150 stores the history of the state of the intermediate calculation unit 120 in the storage unit 160. Specifically, each time the intermediate calculation unit 120 performs a single calculation, the intermediate layer data duplication unit 150 stores in the intermediate layer data storage unit 161 the state of the intermediate calculation unit 120 after the calculation has been performed.

The weighting unit 130 performs weighting on the output of the intermediate calculation unit 120 for each calculation performed by the intermediate calculation unit 120. Specifically, the weighting unit 130 performs weighting respectively on the current output of the intermediate calculation unit 120 and on the output of the intermediate calculation unit 120 in the state of the intermediate calculation unit 120 stored in the intermediate layer data storage unit 161, and outputs the results of weighting to the output layer 140.

The second connection 131 weights the output of the intermediate calculation unit 120 for one state of the intermediate calculation unit 120. That is to say, each weighting unit 131 performs weighting on either the current output of the intermediate calculation unit 120 or the output of the intermediate calculation unit 120 in the state of the intermediate calculation unit 120 being stored in one of the intermediate layer data storage units 161. The second connection 131 outputs the results of weighting to the output layer 140.

The weighting unit 130 includes second connections 131, the number of which is greater by one than the number of states of the intermediate calculation unit 120 stored in the intermediate layer data storage units 161.

As with the output layer 915 of the reservoir computing system 900 (FIG. 1), the output layer 140 is configured by including one or more nodes and outputs output data based on the result of weighting performed by the weighting unit 130.

The learning unit 170 performs learning of weights obtained by weighting performed by the weighting unit 130. On the other hand, the weights in the first connection 121 and the weights in the edges between the nodes of the intermediate layer 122 are not subject to learning, and take a constant value.

The machine learning device 100 that has completed learning corresponds to an example of a processing system.

It can be said that the machine learning device 100 is a type of reservoir computing in that only weight with respect to the output from the intermediate calculation unit 120 to the output layer 140 is subject to learning. In the case where the combination of the intermediate layer 122, the intermediate layer data duplication unit 150, and the intermediate layer data storage unit 161 is regarded as an example of the reservoir computing system 900, the machine learning device 100 corresponds to an example of the reservoir computing system 900.

On the other hand, the machine learning device 100 differs from general reservoir computing in that it includes the intermediate layer data duplication unit 150 and the intermediate layer data storage units 161, and in that the weighting unit 130 performs weighting on the output of the intermediate layer 122 in the state of the intermediate layer 122 stored in the intermediate layer data storage units 161.

As described above, the input layer 110 acquires input data. Specifically, the input layer 110 sequentially acquires input time series data. The intermediate calculation unit 120 performs calculation on acquired input time series data of each time. The weighting unit 130 performs weighting on the output of the intermediate calculation unit for each of the plurality of times. The output layer 140 outputs output data based on the results of the weighting performed by the weighting unit 130. The learning unit 170 performs learning of weights obtained by weighting performed by the weighting unit 130.

In this way, the number of output concatenations can be increased by performing weighting with respect to the outputs from the intermediate layer 122 to the output layer 140 at a plurality of times and using them in the calculation of the outputs. The number of output concatenations referred to here is the number of outputs from all of the nodes of the intermediate layer 122 to all of the nodes of the output layer 140, and includes the outputs from the intermediate layer 122 to the output layer 140 at past times. The number of dimensions of the intermediate layer 122 referred to here is the number of nodes of the intermediate layer 122.

By using outputs from the intermediate layer 122 at the past times, the number of output concatenations can be relatively increased without the need to increase the number of nodes in the intermediate layer 122. Conversely, even when the number of dimensions of the intermediate layer 122 is reduced, the number of output concatenations can be made constant by adding concatenations from past times.

In this way, according to the machine learning device 100, calculation can be performed with relatively high accuracy using a relatively large number of output concatenations without the need to increase the size of the model (the number of nodes in the intermediate layer 122 in particular).

### Second Example Embodiment

In the second example embodiment, an example of processing performed by the machine learning device 100 of the first example embodiment will be described. In the processing according to the second example embodiment, the past state of the intermediate layer 122 is reused.

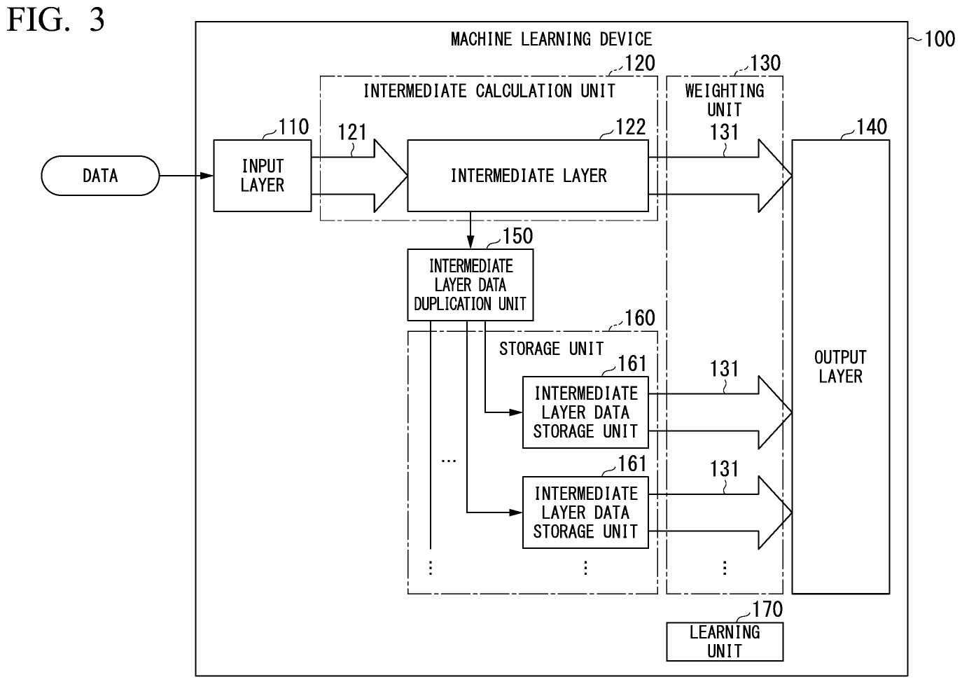

FIG. 3 is a diagram showing a first example of data flow in the machine learning device 100. In the example of FIG. 3, the input layer 110 acquires input data, and the first connection 121 performs weighting with respect to the input data.

The intermediate layer 122 performs calculation on the result of weighting performed by the first connection 121 (input data weighted by the first connection 121). In the second example embodiment, the intermediate layer 122 repeats the same calculation every time the input layer 110 acquires input data. One of the calculations performed repeatedly by the intermediate layer 122 (calculation performed by the intermediate layer 122 in response to one input data acquisition of the input layer 110) corresponds to an example of a single calculation.

Each time the intermediate calculation unit 120 performs a single calculation, the intermediate layer data duplication unit 150 stores in the intermediate layer data storage unit 161, the state of the intermediate layer 122. The weighting unit 130 performs weighting respectively on the output of the intermediate layer 122 and on the output of the intermediate layer 122 in the state of the intermediate layer 122 being stored in the intermediate layer data storage unit 161.

The output layer 140 calculates output data on the basis of the results of weighting performed by the weighting unit 130 and outputs it.

The learning unit 170 performs learning of weights in the output layer 140.

In the processing of the machine learning device 100 of the second example embodiment, let x(t) be the internal state of the intermediate layer 122 at a certain time t (t=0, 1, 2, . . . , T). T is a positive integer.

The time t is indicated by a serial number assigned to the time step in which the intermediate layer 122 performs a single calculation.

In the second example embodiment, the time step in which the intermediate layer 122 performs a single calculation is set to the time step from an acquisition of input data performed by the input layer 110 to the acquisition of the next input data.

As explained with reference to Equation (1), x(t) is expressed as Equation (4), for example.

[Equation 4]

x(t)=f(x(t−Δt),u(t)) (4)

f(·) is a function representing the time evolution of the state of the intermediate layer 122, and here indicates a single calculation performed by the intermediate layer 122. Δt is a prediction time step.

The output vector y(t) indicating the state of the output layer 140 is expressed as Equation (5).

[Equation 5]

y(t)=W^{out}x*(t) (5)

x*(t) is a vector including a state vector indicating the state of the intermediate layer 122 at a time other than the time t, in addition to the state vector indicating the state of the intermediate layer 122 at the time t. x*(t) is expressed as Equation (6).

[Equation 6]

x*(t)=[x(t)^{T},x(t−Q66 t)^{T},x(t−2QΔt)^{T}, . . . , x(t−PQΔt)^{T}]^{T} (6)

Here, [·, ·, ···, ·] represents a concatenation of vectors. Also note that x and x* are vertical vectors. x^{T} represents the transposition of x.

x*(t) is referred to as a mixed time state vector at time t.

Moreover, P is a constant that determines how many past states are used. Q is a constant that determines how many prediction time steps are skipped to use past states. Q is referred to as an extended number.

Moreover, W^{out} in Equation (5) is an output matrix showing the weighting with respect to the mixed state vector x*(t), and is shown as W^{out} ∈ R^{M×(P+1)N}. Here, R^{M×(P+1)N} indicates a set of real number matrices having M rows and (P+1)N columns.

It should be noted that here is shown an example in the case where the output vector y(t) can be calculated by linearly combining the values of elements of the mixed time state vector x*(t). However, the calculation method of the output vector y(t) is not limited to this example. For example, the output layer 140 may calculate it by linearly combining the values of some elements of the mixed time state vector x*(t) after being squared.

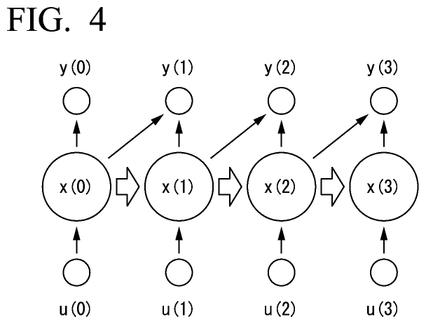

FIG. 4 is a diagram showing an example of state transition in the intermediate layer 122 in the second example embodiment. FIG. 4 shows the time evolution of the state of the intermediate layer 122 from time t=0 to time t=3. FIG. 4 shows an example in the case where P=Q=Δt=1.

In the example of FIG. 4, every time the input layer 110 acquires input data such as u(0), u(1), . . . , the state of the intermediate layer 122 changes in a manner such as x(0), x(1), . . . . The output (output vector y(t)) at a certain time t is found by linearly combining the state (x(t)) of the intermediate layer 122 at time t and the state (x(t−1)) of the intermediate layer 122 at time t−1.

Therefore, in the example of FIG. 4, the weighting unit 130 calculates the output using the results of calculations performed at the two times by the intermediate calculation unit 120. For example, when the intermediate calculation unit 120 calculates x(1) on the basis of x(0) and u(1), and calculates x(2) on the basis of x(1) and u(2), the weighting unit 130 calculates y(2) using x(1) and x(2).

When the intermediate layer 122 calculates the state at time t(vector x(t)), the intermediate layer data duplication unit 150 stores the state of the intermediate layer 122 at time tin the intermediate layer data storage unit 161. Subsequently, the intermediate layer 122 calculates the state (vector x(t+1)) at time t+1. As a result, the weighting unit 130 can calculate the output (output vector y(t+1)) using both the output of the intermediate layer 122 at time t and the output of the intermediate layer 122 at time t+1.

As described above, the intermediate calculation unit 120 performs a single calculation during a period of time from the moment where the input layer 110 acquires input data to the moment where it acquires the next input data.

By the storage unit 160 storing the history of the state of the intermediate calculation unit 120, it is possible to use outputs from the intermediate layer 122 at past times, and the number of output concatenations can be relatively increased without the need to increase the number of nodes in the intermediate layer 122.

### Third Example Embodiment

In the third example embodiment, another example of processing performed by the machine learning device 100 of the first example embodiment will be described. In the processing according to the third example embodiment, an intermediate state of the intermediate layer 122 is provided.

The flow of data in the machine learning apparatus 100 in the processing of the third example embodiment is similar to that described with reference to FIG. 3.

However, in the process of the third example embodiment, the relationship between the timing at which the input layer 110 acquires input data and the timing at which the intermediate calculation unit 120 performs calculation is different from that in the case of the second example embodiment.

In the second example embodiment, the intermediate calculation unit 120 performs a single calculation during a period of time from the moment where the input layer 110 acquires input data to the moment where it acquires the next input data. In contrast, in the third example embodiment, the intermediate calculation unit 120 performs calculation a plurality of times during a period of time from the moment where the input layer 110 acquires input data to the moment where it acquires the next input data. In such a case, the state of the intermediate calculation unit 120 each time the intermediate calculation unit 120 performs a single calculation is referred to as an intermediate state of the intermediate calculation unit 120.

In this way, as a result of the intermediate calculation unit 120 performing a single calculation on the basis of input data and the initial state of the intermediate layer 122, an intermediate state (first intermediate state) of the intermediate layer 122 can be obtained.

As a result of the intermediate calculation unit 120 performing a single calculation on the basis of input data and the intermediate state of the intermediate layer 122, subsequent intermediate states (second, third, . . . , intermediate state) of the intermediate layer 122 are obtained. On the basis of a plurality of intermediate states obtained by the intermediate calculation unit 120 repeating calculation (single calculation) twice or more, the weighting unit 130 and the output layer 140 generate and output an output as a processing result of the machine learning device 100.

In the processing of the third example embodiment, n^{tran} intermediate states are inserted into the state of the intermediate layer 122. N^{tran} is a positive integer. Each intermediate state is the state of the intermediate layer 122 stored in the intermediate layer data storage unit 161.

In the third example embodiment in which intermediate states of the intermediate layer 122 are provided, the weighting unit 130 calculates an output layer after the intermediate layer 122 has performed a time evolution using the same input signal (1+N^{tran}) times. The internal state (vector x(t)) of the intermediate layer 122 in this case is expressed as Equation (7), for example.

$$\begin{matrix}[ Equation 7 ] & \\ x ( t ) = f ( x ( t - Δ t ) , u ( floor ( \frac{t}{1 + {N}^{tran}} ) ) ) & ( 7 )\end{matrix}$$

Here, floor (·) is called a floor function and is defined as Equation (8).

[Equation 8]

floor(x)=max{n ∈ [symbol] |n≤x} (8)

Here, Z is a set of integers.

f(·) is a function representing the time evolution of the state of the intermediate layer 122, and indicates a single calculation performed by the intermediate layer 122 as with the case of Equation (4).

The output vector y(t) indicating the state of the output layer 140 is expressed as Equation (9).

[Equation 9]

y(t)=^{out}x*((1+N^{tran})t+N^{tran}) (9)

The mixed time state vector x*(t) is expressed as Equation (6).

W^{out} in Equation (9) is an output matrix showing the weighting with respect to the mixed state vector x*(t), and is shown as Wout ∈ R^{M×(1×Ntran)N}. Here, R^{M×(1+Ntran)N} indicates a set of real number matrices having M rows and (1+N^{tran})N columns.

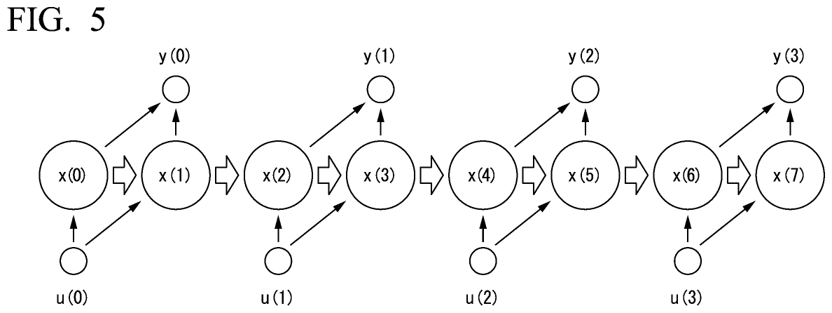

FIG. 5 is a diagram showing an example of state transition in the intermediate layer 122 in the third example embodiment. FIG. 5 shows the time evolution of the state of the intermediate layer 122 from time t=0 to time t=3. In FIG. 5 there is shown an example of the case where one intermediate state is inserted (that is, where N^{tran=1}) and also P=Q=Δt=1. x*(·) is a vector indicating the intermediate state of the intermediate layer 122.

In the example of FIG. 5, every time the input layer 110 acquires input data such as u(0), u(1), . . . , the state of the intermediate layer 122 transitions to the final state with respect to the input data through intermediate states, that is, x*(0), x*(1), x*(2), . . . . Moreover, the output (output vector y(t)) at a certain time t is found by linearly combining the intermediate state (x((1+N^{tran})t+N^{tran})) of the intermediate layer 122 and the state (x((1+N^{tran})t+N^{tran}−1)) at a time therebefore.

Therefore, in the example of FIG. 5, the weighting unit 130 calculates the output using the results of two calculations performed by the intermediate calculation unit 120. For example, when the intermediate calculation unit 120 calculates x(2) on the basis of x(1) and u(1), and calculates x(3) on the basis of x(2) and u(1), the weighting unit 130 calculates y(1) using x(2) and x(3).

When the intermediate layer 122 calculates an intermediate state, the intermediate layer data duplication unit 150 stores the intermediate state of the intermediate layer 122 in the intermediate layer data storage unit 161. Thereafter, the intermediate layer 122 calculates the next intermediate state or the final state with respect to the input data. As a result, the weighting unit 130 can calculate the output (output vector y(t)) using both the output of the intermediate layer 122 in the intermediate state and the output of the intermediate layer 122 in the final state with respect to the input data.

As described above, the intermediate calculation unit 120 performs calculation a plurality of times during a period of time from the moment where the input layer 110 acquires input data to the moment where it acquires the next input data. For example, the intermediate calculation unit 120 performs calculation a plurality of times sequentially.

By the storage unit 160 storing the history of the state of the intermediate calculation unit 120 as intermediate states, it is possible to use outputs from the intermediate layer 122 in intermediate states, and the number of output concatenations can be increased without the need to increase the number of nodes in the intermediate layer 122.

### Fourth Example Embodiment

In a fourth example embodiment, an example of still another processing performed by the machine learning device 100 of the first example embodiment will be described. In the processing according to the fourth example embodiment, an auxiliary state of the intermediate layer 122 is provided.

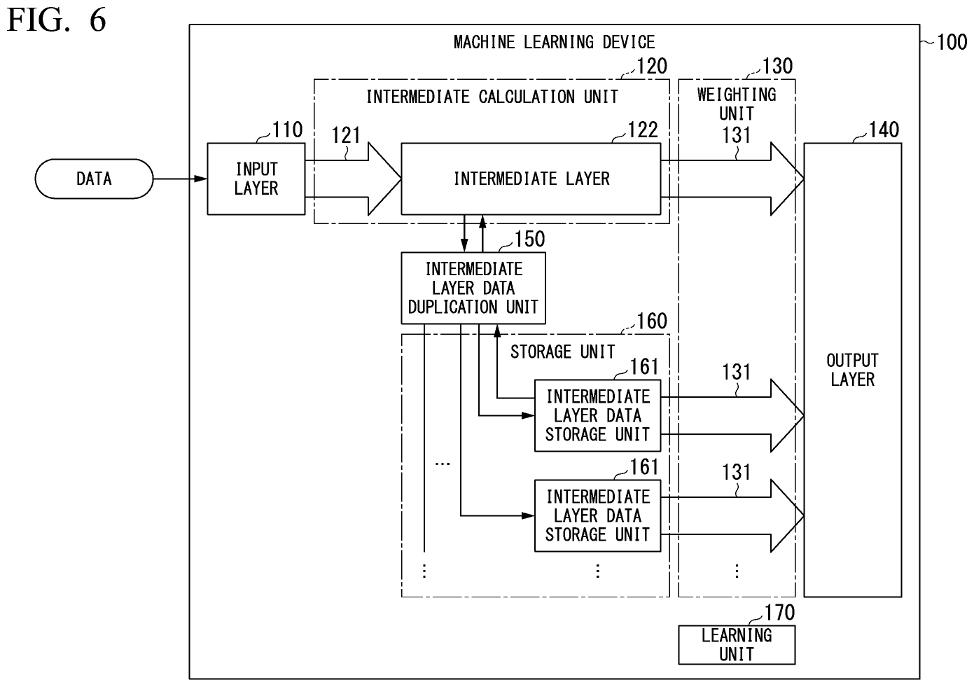

FIG. 6 is a diagram showing a second example of data flow in the machine learning device 100. The example of FIG. 6 differs from the case of FIG. 3 in that the intermediate layer data duplication unit 150 reads out the state of the intermediate layer 122 from the intermediate layer data storage unit 161 and sets it to the intermediate layer 122. In other respects, the example of FIG. 6 is similar to that in the case of FIG. 3.

As with the case of the third example embodiment, in the fourth example embodiment, the intermediate calculation unit 120 performs calculation a plurality of times during a period of time from the moment where the input layer 110 acquires input data to the moment where it acquires the next input data. In such a case, the state of the intermediate calculation unit 120 each time the intermediate calculation unit 120 performs a single calculation is referred to as an auxiliary state of the intermediate calculation unit 120.

The difference between intermediate states and auxiliary states of the intermediate layer 122 is whether or not a return of state transition occurs. As described in the third example embodiment, in the case of an intermediate state, the state of the intermediate layer 122 transitions to the final state with respect to input data through one or more intermediate states. The intermediate layer 122 performs a state calculation with respect to the next input data on the basis of the final state with respect to the input data. Thus, in the case of intermediate states, a return does not occur in state transition of the intermediate layer 122.

On the other hand, in the case of auxiliary states, the state of the intermediate layer 122 transitions to one or more auxiliary states, then returns to the original state, and then transitions to the state with respect to the next input data. Thus, in the case of auxiliary states, a return occurs in state transition of the intermediate layer 122.

In the machine learning device 100 in the fourth example embodiment, N^{aux} auxiliary states are added with respect to the state of the intermediate layer 122 at each time (the state of the intermediate layer 122 at each time step where the input layer 110 acquires input data). N^{aux} is a positive integer. The state of the intermediate layer 122 at each time is expressed as Equation (4), for example.

Moreover, an auxiliary state x(t;i) is expressed as Equation (10).

$$\begin{matrix}[ Equation 10 ] & \\ x ( t ; i ) = \{ \begin{matrix}g ( x ( t ) ) , when i = 1 , \\ g ( x ( t ; i - 1 ) ) , when i > 1\end{matrix} & ( 10 )\end{matrix}$$

Here, g(·) may be the same function as f(·) or may be a different function.

Also, in the fourth example embodiment, the mixed time state vector x*(t) is expressed as Equation (11).

[Equation 11]

x*(t)=[x(t)^{T},x(t; 1)^{T},x(t; 2)^{T}, . . . , x(t; N^{aux})^{T}]^{T} (11)

In the fourth example embodiment, the output vector y(t) indicating the state of the output layer 140 is expressed as Equation (12).

[Equation 12]

y(t)W^{out}x*(t) (12)

W^{out} in Equation (12) is an output matrix showing the weighting with respect to the mixed state vector x*(t), and is shown as W^{out} ∈ R^{M×(1+Naux)N}. Here, R^{M×(1+Naux)N} indicates a set of real number matrices having M rows and (1+N^{aux})N columns.

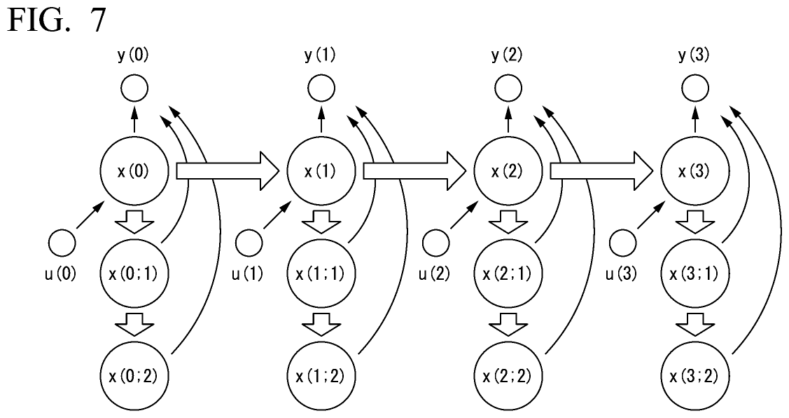

FIG. 7 is a diagram showing an example of state transition in the intermediate layer 122 in the fourth example embodiment. FIG. 7 shows the time evolution of the state of the intermediate layer 122 from time t=0 to time t=3. In FIG. 7 there is shown an example of the case where two auxiliaries are inserted (that is, where N^{aux}=2) and also Δt=1. x(·) is a vector indicating the intermediate state of the intermediate layer 122.

In the example of FIG. 7, the state of the intermediate layer 122 transitions to an auxiliary state, then returns to the original state, and then transitions to the state for the next input data, that is to say, the state transitions from x(0) to x(0;1) and x(0:2), then returns to x(0) or transitions from x(1) to x(1;1) and x(1:2), then returns to x(1).

The output (output vector y(t)) at a certain time t is found by linearly combining the state (x(t)) of the intermediate layer 122 at time t and the auxiliary state (x(t;1)) of the intermediate layer 122 at time t.

Therefore, in the example of FIG. 7, the weighting unit 130 calculates the output using the results of two calculations performed by the intermediate calculation unit 120. For example, when the intermediate calculation unit 120 calculates x(0;1) on the basis of x(0) and u(0), and calculates x(0;2) on the basis of x(0;1), the weighting unit 130 calculates y(0) using x(0), x(0;1), and x(0;2).

The intermediate layer data duplication unit 150 stores in the intermediate layer data storage unit 161 the state of the intermediate layer 122 prior to calculating an auxiliary state. Subsequently, the intermediate layer 122 calculates an auxiliary state. Each time the intermediate layer 122 calculates an auxiliary state, the intermediate layer data duplication unit 150 stores the auxiliary state in the intermediate layer data storage unit 161. As a result, the weighting unit 130 can calculate the output (output vector y(t)) using both the output of the intermediate layer 122 in the auxiliary state and the output of the intermediate layer 122 in the original state.

When the intermediate layer 122 has completed the calculation of N^{aux} auxiliary states, the intermediate layer data duplication unit 150 reads out the original state of the intermediate layer 122 from the intermediate layer data storage unit 161 and sets it to the intermediate layer 122.

As described above, the intermediate calculation unit 120 performs calculation a plurality of times during a period of time from the moment where the input layer 110 acquires input data to the moment where it acquires the next input data. For example, the intermediate calculation unit 120 performs calculation a plurality of times sequentially. Upon the input layer 110 acquiring the next input data, the intermediate calculation unit 120 starts performing calculation on the next input data from the state prior to performing calculation at least some of the plurality of times.

By the storage unit 160 storing the history of the state of the intermediate calculation unit 120 as auxiliary states, it is possible to use outputs from the intermediate layer 122 in auxiliary states, and the number of output concatenations can be increased without the need to increase the number of nodes in the intermediate layer 122.

The machine learning device 100 may use either one or both of the processing of the second example embodiment and the processing of the third example embodiment, in combination with the processing of the fourth example embodiment.

For example, in the example of FIG. 4, the time step from the moment where the input layer 110 acquires input data to the moment where it acquires the next input data may be divided into a plurality of substeps, and the intermediate layer 122 may calculate an auxiliary state for each substep.

Moreover, in the example of FIG. 5, the input layer 110 may calculate an auxiliary state from states such as x(0) and x(1), then return to the original state, and then calculate the intermediate state with respect to the next input data.

In the case of configuring the machine learning device 100 with use of a neural network, the intermediate layer 122 can be configured by using various neuron models and various network connections. For example, the intermediate layer 122 may be configured as a fully connected neural network. Alternatively, the intermediate layer 122 may be configured as a neural network of a torus connection type.

### (Simulation Example)

Simulation results of the operation of the machine learning device 100 will be described.

In the simulation, the machine learning device 100 is configured using a neural network, and the number of nodes in the input layer 110 and the number of nodes in the output layer 140 are both set to 1. Furthermore, Q=Δt=1. The state of the intermediate layer 122 in the simulation is shown as represented by the vector x(t) in Equation (13).

[Equation 13]

x(t)=tanh(W^{res}x(t−1)+Wⁱⁿu(t)) (13)

The mixed time state vector x*(t) is expressed as Equation (14).

[Equation 14]

x*(t)=[x(t)^{T},x(t−1)^{T},x(t−2)^{T}, . . . , x(t−P)^{T}]^{T} (14)

The output vector y(t) is expressed as Equation (5).

In the case of introducing intermediate states, the state of the intermediate layer 122 is shown as represented by the vector x(t) in Equation (15).

$$\begin{matrix}[ Equation 15 ] & \\ x ( t ) = tanh ( {w}^{r e s} x ( t - 1 ) + {w}^{i n} u ( floor ( \frac{t}{1 + {N}^{tran}} ) ) ) & ( 15 )\end{matrix}$$

In the case of introducing intermediate states, the mixed time state vector x*(t) is expressed as above Equation (6). In the case of introducing intermediate states, the output vector y(t) is expressed as Equation (9).

In the case of introducing auxiliary states, the state of the intermediate layer 122 is shown as represented by the vector x(t) in Equation (16).

[Equation 16]

x(t)=tanh(W^{res}x(t−1)+Wⁱⁿu(t)) (16)

An auxiliary state of the intermediate layer 122 is shown as represented by the vector x(t;i) in Equation (17).

$$\begin{matrix}[ Equation 17 ] & \\ x ( t ; i ) = \{ \begin{matrix}tanh ( {W}^{r e s} x ( t ) ) , when i = 1 , \\ tanh ( {W}^{r e s} x ( t ; i - 1 ) ) when i > 1\end{matrix} & ( 17 )\end{matrix}$$

In the case of introducing auxiliary states, the mixed time state vector x*(t) is expressed as Equation (11). In the case of introducing auxiliary states, the output vector y(t) is expressed as Equation (12).

In the simulation, a task of predicting the output of NARMA10 was performed. NARMA10 is expressed as Equation (18).

$$\begin{matrix}[ Equation 18 ] & \\ {y}^{Te} [ t ] = 0.3 {y}^{Te} [ t - 1 ] + 0.05 {y}^{Te} [ t - 1 ] {\sum }_{i = 1}^{10} {y}^{Te} [ t - i ] + 1.5 u [ t - 9 ] u [ t ] + 0.1 & ( 18 )\end{matrix}$$

Here, u[t] is a uniform random number taking a value from 0 to 0.5. Network learning is performed with Tₜᵣₐᵢₙ(=2,000) pieces of data, and the regression performance of the output thereof is examined for Tₜₑₛₜ(=2,000) pieces of data, using different random numbers.

The regression performance was evaluated using a normalized mean square error (NMSE). An NMSE is expressed as Equation (19).

$$\begin{matrix}[ Equation 19 ] & \\ N M S E = \frac{{\sum }_{t = 1}^{{T}_{test}} {( {y}^{Te} ( t ) - y ( t ) )}^{2}}{{\sum }_{t = 1}^{{T}_{test}} {( {y}^{Te} ( t ) - {y}^{m e a n} )}^{2}} & ( 19 )\end{matrix}$$

y^{mean} is expressed as Equation (20).

$$\begin{matrix}[ Equation 20 ] & \\ {y}^{m e a n} = \frac{{Σ}_{i = 0}^{{T}_{test}} {y}^{Te} ( t )}{{T}_{test}} & ( 20 )\end{matrix}$$

Here, y^{Te} is an output value (teaching data) of NARMA10, and y(t) is a prediction value of the network. The smaller the NMSE, the higher the performance.

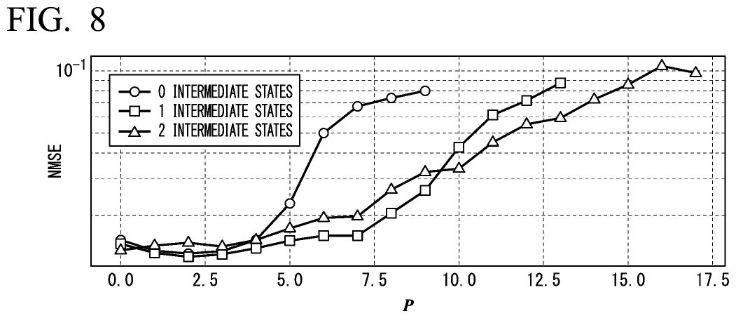

FIG. 8 is a first diagram showing simulation results where NP=200. Note that N is the number of neurons in the reservoir layer, and P is the number of past states that allow concatenation. The horizontal axis in FIG. 8 represents the size of P. The larger P is, the smaller the number of nodes (number of neurons) in the intermediate layer 122 is. FIG. 8 shows the results when the number of intermediate states is 0, 1, or 2. It can be seen that when the number of intermediate states is any of those numbers, NMSE as a performance value has a similar value where P=0, 1, 2, 3, or 4. The number of nodes when P=4 is 40, and the number of nodes can be reduced in the intermediate layer 122.

Moreover, when intermediate states were inserted, the reduction in performance was small up to P=7 or so, and a smaller number of nodes can be realized in the intermediate layer 122.

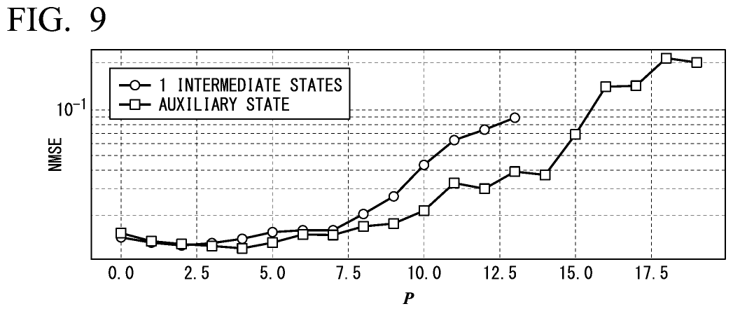

FIG. 9 is a second diagram showing simulation results where NP=200. The horizontal axis in FIG. 9 represents the size of P. FIG. 9 shows a comparison under the above conditions, between a case where there is one intermediate state and a case where auxiliary states are used. When auxiliary states are used, the reduction in performance is small up to P=10 or so, and a greater reduction is possible in the number of neurons in the intermediate layer 122 compared to the case of introducing the intermediate state.

### Fifth Example Embodiment

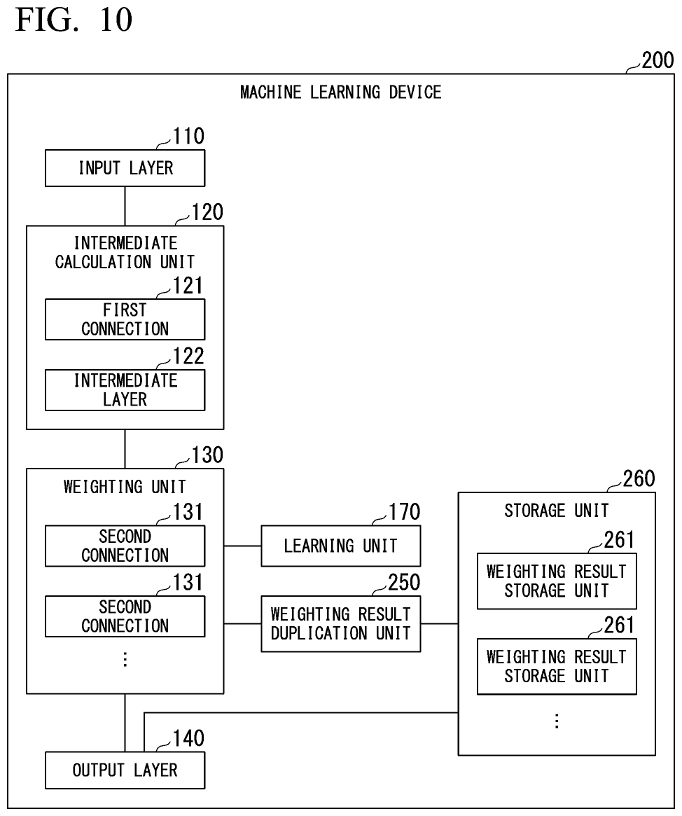

FIG. 10 is a diagram showing an example of a functional configuration of a machine learning device according to a fifth example embodiment. In the configuration shown in FIG. 10, a machine learning device 200 includes an input layer 110, an intermediate calculation unit 120, a weighting unit 130, an output layer 140, a weighting result duplication unit 250, a storage unit 260, and a learning unit 170. The intermediate calculation unit 120 includes a first connection 121 and an intermediate layer 122. The weighting unit 130 includes second connections 131. The storage unit 260 includes weighting result storage units 261.

Of the components shown in FIG. 10, ones corresponding to those in FIG. 2 and having the same functions are given the same reference symbols (110, 120, 121, 122, 130, 131, 140, and 170), and descriptions thereof are omitted. The machine learning device 200 differs from the machine learning device 100 in that it includes the weighting result duplication unit 250 in place of the intermediate layer data duplication unit 150 and in that it includes the storage unit 260 including the weighting result storage units 261 in place of the storage unit 160 including the intermediate layer data storage units 161. In other respects, the machine learning device 200 is similar to the machine learning device 100.

In the machine learning device 100, the intermediate layer data storage unit 161 stores the state of the intermediate layer 122, whereas in the machine learning device 200, the weighting result storage unit 261 stores the result of the second connection 131 performing weighting on the output of the intermediate layer 122. In the machine learning device 100, the intermediate layer data duplication unit 150 stores the state of the intermediate layer 122 in the intermediate layer data storage unit 161, whereas in the machine learning device 200, the weighting result duplication unit 250 stores in the weighting result storage unit 261 the result of the second connection 131 performing weighting on the output of the intermediate layer 122.

In the machine learning device 200, the weighting unit 130 performs weighting on the output of the intermediate layer 122 every time the intermediate layer 122 calculates a state, so that the storage unit 260 does not have to store the state of the intermediate layer 122. This weighting is shown by the resolution of the calculation equation of the output vector y(t).

The calculation equation prior to the resolution is expressed as Equation (21).

[Equation 21]

y(t)=W^{out}[x(t)^{T},x(t−QΔt)^{T},x(t−2QΔt)^{T}, . . . , x(t−PQΔt)^{T}]^{T} (21)

This equation is resolved as shown in Equation (22).

[Equation 22]

y(t)=W₀^{out}x(t)+W₁^{out}x(t−QΔt)+W₂^{out}x(t−2QΔt)+ . . . +W_{P}^{out}x(t−PQΔt) (22)

Here is W^{out} ∈ R^{M×(P+1)N}, and Wᵢ^{out} ∈ R^{M×N} (i=0, 1, . . . , P).

In order to eliminate the need to store the state of the intermediate layer 122, when the intermediate layer 122 calculates the state x(t) of the intermediate layer 122 itself at time t, the weighting unit 130 performs weighting on the output of the intermediate layer 122. This weighting is expressed as Equation (23).

[Equation 23]

W₀^{out}x(t), W₁^{out}x(t), W₂^{out}x(t), . . . , W_{P}^{out}x(t) (23)

As a result, the size of the memory held is reduced by the factor of M/N. N indicates the number of nodes in the intermediate layer 122, and M indicates the number of nodes in the output layer 140. In general, the number of nodes in the intermediate layer 122 is greater than the number of nodes in the output layer 140.

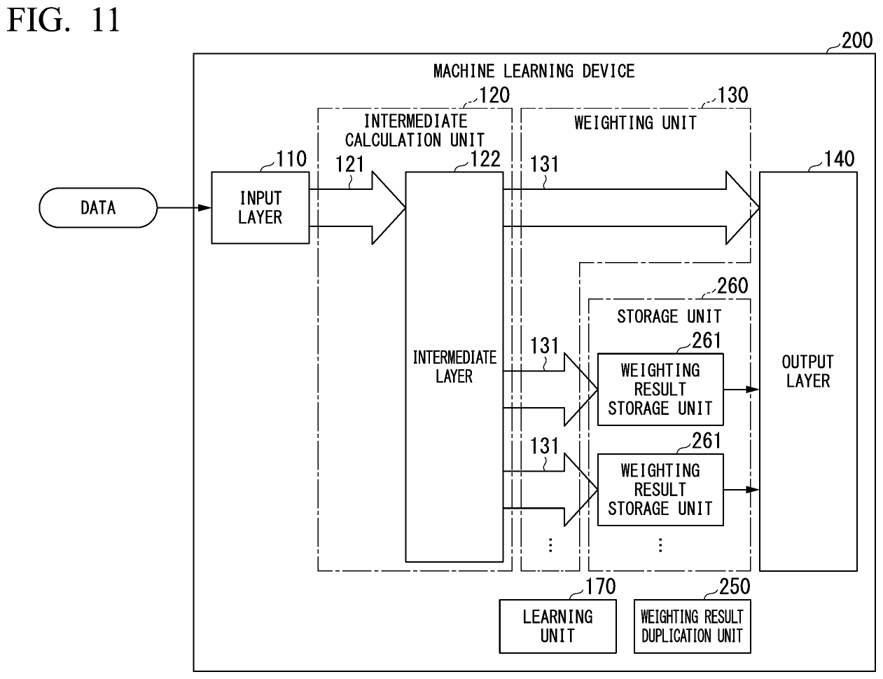

FIG. 11 is a diagram showing an example of data flow in the machine learning device 200. In the example of FIG. 11, the input layer 110 acquires input data, and the first connection 121 performs weighting with respect to the input data.

The intermediate layer 122 performs calculation on the result of weighting performed by the first connection 121 (input data weighted by the first connection 121).

The weighting unit 130 performs weighting on the output of the intermediate calculation unit 120 (output of the intermediate layer 122) every time the intermediate calculation unit 120 performs a single calculation. The weighting result duplication unit 250 stores in the weighting result storage unit 261 the result of the weighting unit 130 performing weighting.

The output layer 140 calculates and outputs output data on the basis of the results of weighting performed by the weighting unit 130 on the output of the intermediate layer 122, and the weighting result stored in the weighting result storage unit 261.

The learning unit 170 performs learning of weights in the output layer 140.

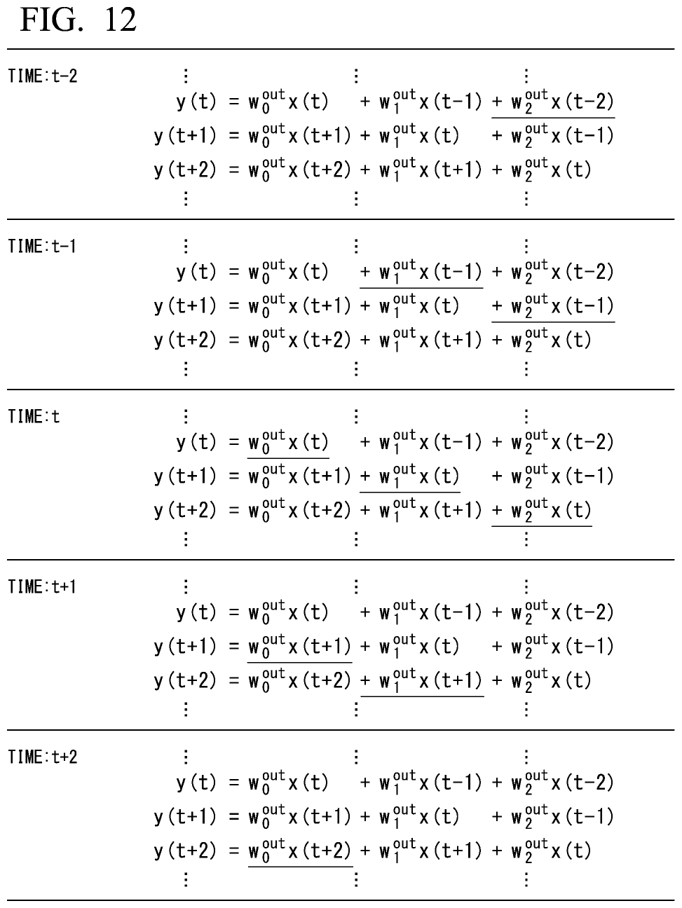

FIG. 12 is a diagram showing an example of calculation performed at respective times by the weighting unit 130. Of the terms in the equations shown in FIG. 12, the term calculated by the weighting unit 130 at each time is underlined.

Thus, the weighting unit 130 divides the weighting of the output of the intermediate layer 122 by time.

As mentioned above, the weighting result storage unit 261 stores the result of weighting performed by the weighting unit 130 on the output of the intermediate layer 122 at each of the plurality of times.

As a result, the size of the memory held by the storage unit 260 can be relatively small.

The fifth example embodiment can be applied to any of the second to fourth example embodiments. When applying the fifth example embodiment to the fourth example embodiment, the storage unit 260 stores the original state for reverting the state of the intermediate layer 122 to the original state.

The machine learning device 100 or the machine learning device 200 described above can be made efficient through software. Furthermore, the machine learning device 100 or the machine learning device 200 described above can perform calculations efficiently through hardware. As hardware in such a case, for example, not only hardware using electronic circuits such as GPU, FPGA, and ASICS, but also hardware using laser, spintronics, or the like may be used, and these pieces of hardware may be used in combination.

### Sixth Example Embodiment

In the sixth example embodiment, an example of the configuration of a machine learning device of an example embodiment will be described.

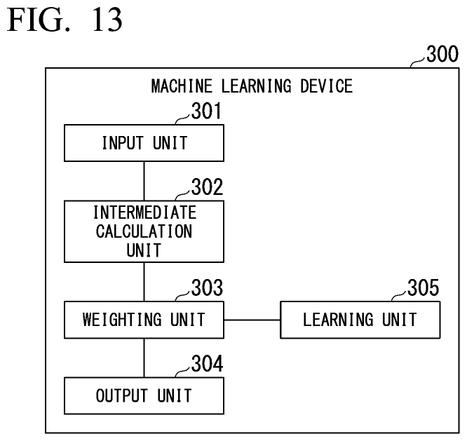

FIG. 13 is a diagram showing a configuration example of a machine learning device according to the example embodiment. A machine learning device 300 shown in FIG. 13 includes an input unit 301, an intermediate calculation unit 302, a weighting unit 303, an output unit 304, and a learning unit 305.

In this configuration, the input unit 301 acquires input data. The intermediate calculation unit 302 performs calculation a plurality of times on input data acquired by the input unit 301. For example, the intermediate calculation unit 302 performs calculation a plurality of times sequentially. The weighting unit 303 performs weighting on the output of the intermediate calculation unit at each of the plurality of times. The output unit 304 outputs output data on the basis of the results of the weighting performed by the weighting unit 303. The learning unit 305 performs learning of weights obtained by weighting performed by the weighting unit 303.

According to the machine learning device 300, the output from the output unit 304 can be calculated using the state of the intermediate calculation unit 302 at each of the plurality of timings, and it is possible to make the number of output concatenations greater than the number of dimensions of the intermediate calculation unit 302. In this respect, according to the machine learning device 300, calculation can be performed with relatively high accuracy using a relatively large number of output concatenations without the need to increase the size of the model (the number of nodes in the intermediate calculation unit 302 in particular).

### Seventh Example Embodiment

In the seventh example embodiment, an example of an information processing method according to an example embodiment will be described.

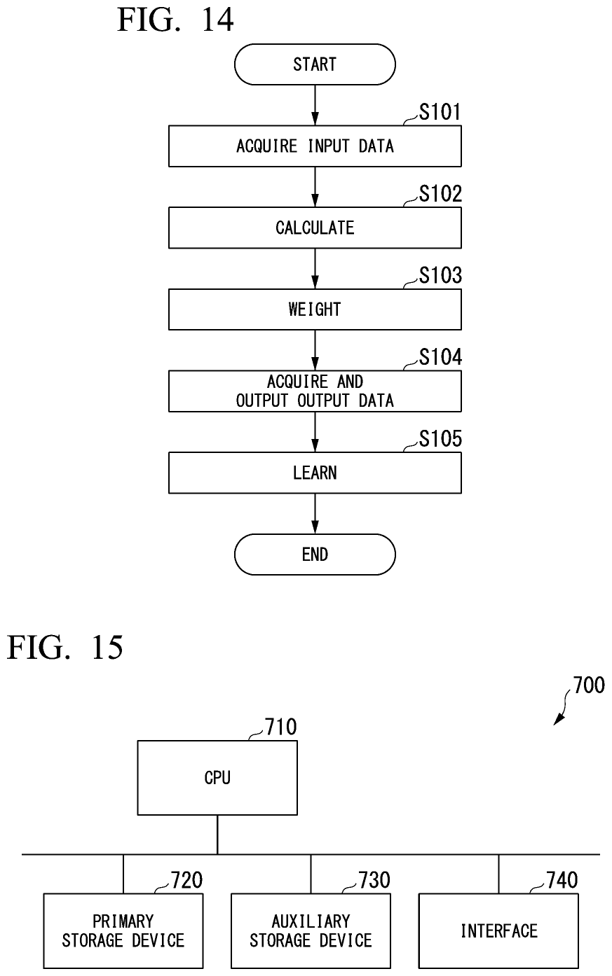

FIG. 14 is a diagram showing an example of a processing procedure in the information processing method according to the example embodiment. For example, the machine learning device 300 of FIG. 13 performs the processing of FIG. 14.

The processing of FIG. 14 includes: a step of acquiring input data (Step S101); a step of performing calculation a plurality of times on input data sequentially, for example (Step S102); a step of performing weighting on the result of calculation at each of the plurality of times (Step S103); a step of outputting output data on the basis of the weighting results (Step S104); and a step of performing learning of weights obtained by the weighting (Step S105).

According to the information processing method of FIG. 14, the output in Step S104 can be calculated, using the calculation result at each of the plurality of times in Step S102. According to the information processing method in FIG. 14, calculation of output can be performed with relatively high accuracy using a relatively large number of pieces of data without the need to increase the size of the model.

FIG. 15 is a schematic block diagram showing a configuration of a computer according to at least one example embodiment.

In the configuration shown in FIG. 15, a computer 700 includes a CPU (Central Processing Unit) 710, a primary storage device 720, an auxiliary storage device 730, and an interface 740.

One or more of the machine learning devices 100, 200, and 300 may be implemented in the computer 700. In such a case, operations of the respective processing units described above are stored in the auxiliary storage device 730 in the form of a program. The CPU 710 reads out the program from the auxiliary storage device 730, loads it on the primary storage device 720, and executes the processing described above according to the program. Moreover, the CPU 710 secures, according to the program, storage regions corresponding to the respective storage units mentioned above, in the primary storage device 720.

In the case where the machine learning device 100 is implemented in the computer 700, operations of the intermediate calculation unit 120, the weighting unit 130, the intermediate layer data duplication unit 150, and the learning unit 170 are stored in the auxiliary storage device 730 in the form of a program. The CPU 710 reads out the program from the auxiliary storage device 730, loads it on the primary storage device 720, and executes the operation of each unit according to the program.

Data acquisition performed by the input layer 110 is executed by the interface 740 having, for example, a communication function, and receiving data from another device under the control of the CPU 710. Data output performed by the output layer 140 is executed by the interface 740 having, for example, a communication function or an output function such as a displaying function, and performing an output process under the control of the CPU 710. Moreover, the CPU 710 secures in the primary storage device 720 a storage region corresponding to the storage unit 160.

In the case where the machine learning device 200 is implemented in the computer 700, operations of the intermediate calculation unit 120, the weighting unit 130, the weighting result duplication unit 250, and the learning unit 170 are stored in the auxiliary storage device 730 in the form of a program. The CPU 710 reads out the program from the auxiliary storage device 730, loads it on the primary storage device 720, and executes the operation of each unit according to the program.

Data acquisition performed by the input layer 110 is executed by the interface 740 having, for example, a communication function, and receiving data from another device under the control of the CPU 710. Data output performed by the output layer 140 is executed by the interface 740 having, for example, a communication function or an output function such as displaying function, and performing an output process under the control of the CPU 710. Moreover, the CPU 710 secures in the primary storage device 720 a storage region corresponding to the storage unit 260.

In the case where the machine learning device 300 is implemented in the computer 700, operations of the intermediate calculation unit 302, the weighting unit 303, and the learning unit 305 are stored in the auxiliary storage device 730 in the form of a program. The CPU 710 reads out the program from the auxiliary storage device 730, loads it on the primary storage device 720, and executes the operation of each unit according to the program.

Data acquisition performed by the input unit 301 is executed by the interface 740 having, for example, a communication function, and receiving data from another device under the control of the CPU 710. Data output performed by the output unit 304 is executed by the interface 740 having, for example, a communication function or an output function such as a displaying function, and performing an output process under the control of the CPU 710. Moreover, the CPU 710 secures in the primary storage device 720 a storage region corresponding to the storage unit 260.

It should be noted that a program for realizing all or part of the functions of the machine learning devices 100, 200, and 300 may be recorded on a computer-readable recording medium, and the program recorded on the recording medium may be read into and executed on a computer system, to thereby perform the processing of each unit. The “computer system” referred to here includes an OS (operating system) and hardware such as peripheral devices.

Moreover, the “computer-readable recording medium” referred to here refers to a portable medium such as a flexible disk, a magnetic optical disk, a ROM (Read Only Memory), and a CD-ROM (Compact Disc Read Only Memory), or a storage device such as a hard disk built in a computer system. The above program may be a program for realizing a part of the functions described above, and may be a program capable of realizing the functions described above in combination with a program already recorded in a computer system.

The example embodiments of the present invention have been described in detail with reference to the drawings. However, the specific configuration of the invention is not limited to these example embodiments, and may include designs and so forth that do not depart from the scope of the present invention.

This application is based upon and claims the benefit of priority from Japanese patent application No. 2019-206438, filed Nov. 14, 2019, the disclosure of which is incorporated herein in its entirety by reference.

### INDUSTRIAL APPLICABILITY

The present invention may be applied to a machine learning device, an information processing method, and a recording medium.

### DESCRIPTION OF REFERENCE SYMBOLS

100, 200, 300 Machine learning device
110 Input layer
120, 302 Intermediate calculation unit (intermediate calculation means)
121 First connection
122 Intermediate layer
130, 303 Weighting unit (weighting means)
131 Second connection
140 Output layer
150 Intermediate layer data duplication unit (intermediate layer data duplication means)
160, 260 Storage unit (storage means)
161 Intermediate layer data storage unit (intermediate layer data storage means)
170, 305 Learning unit (learning means)
200 Machine learning device
250 Weighting result duplication unit (weighting result duplication means)
261 Weighting result storage unit (weighting result storage means)
301 Input unit (input means)
304 Output unit (output means)

1. A machine learning device comprising:
an interface configured to acquire input data; and
a processor configured to execute instructions to:
perform calculation on the input data a plurality of times to obtain a plurality of results; and
perform weighting on each of the plurality results,
wherein the interface is configured to output output data based on a result of the weighting, and
the processor is configured to execute the instructions to perform learning of a weight obtained by the weighting.

2. The machine learning device according to claim 1, wherein the processor is configured to execute the instructions to perform calculation once during a period of time from a moment where the interface acquires input data to a moment where the interface acquires next input data.

3. The machine learning device according to claim 1, wherein the processor is configured to execute the instructions to perform calculation a plurality of times during a period of time from a moment where the interface acquires input data to a moment where the acquires next input data.

4. The machine learning device according to claim 1, wherein the processor is configured to execute the instructions to:
perform calculation a plurality of times during a period of time from a moment where the interface acquires input data to a moment where the interface acquires next input data; and
upon the interface acquiring the next input data, start performing calculation on the next input data from a state prior to performing calculation at least some of the plurality of times.

5. The machine learning device according to claim 1, further comprising:
a memory configured to store the result of the weighting.

6. An information processing method comprising:
acquiring input data;
performing calculation on the input data a plurality of times to obtain a plurality of results;
performing weighting on each of the plurality of results;
outputting output data based on a result of the weighting; and
performing learning of a weight obtained by the weighting.

7. A non-transitory recording medium that stores a program causing a computer to execute:
acquiring input data;
performing calculation on the input data a plurality of times to obtain a plurality of results;
performing weighting on each of the plurality of results;
outputting output data based on a result of the weighting; and
performing learning of a weight obtained by the weighting.
